(19) United States
(12) Patent Application Publication
(10) Pub. No.: US 2009/0289424 A1
(43) Pub. Date: Nov. 26, 2009

(54) Ball Joint Dust Seal With Lubricating Flutes

(75) Inventors: Brian K. Fella, Centergrove, IN (US); Alan J. Rogers, Greenwood, IN (US); J. Andy Root, Greensburg, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 12/123,560

(22) Filed: May 20, 2008

(51) Int. Cl. F16J 15/02

(52) U.S. Cl. 277/641

(57) ABSTRACT

A ball joint seal is provided including an annular seal body including a first axial end and a second axial end. The first axial end acts as a dynamic seal end and includes at least one axially extending seal lip and at least one radially inwardly extending seal lip. The axially extending seal lip and the radially inwardly extending seal lip includes a channel extending therethrough that allows grease to migrate from the ball joint to the axial sealing surface of the dynamic seal. The grease that is allowed to migrate from the ball joint to the sealing surfaces of the dynamic seal help to lubricate these surfaces to improve the service life of the seal and, ultimately, the ball joint assembly.

### FIELD

The present disclosure relates to ball joints and more particularly to a ball joint dust seal.

### BACKGROUND AND SUMMARY

The statements in this section merely provide background information related to the present disclosure and may not constitute prior art.

Ball joints are commonly used in numerous applications such as vehicle stabilizer bar links, vehicle suspension control arms, vehicle tie rod ends, and other non-vehicle applications. Ball joints typically include a ball shaft attached to one of two members to be interconnected with each other by the joint and a ball housing accommodating the ball therein. The ball housing being attached to the other member. The ball joints can be positioned underneath a vehicle and exposed to the elements such that they require a ball joint seal to cover the joint in order to prevent dust and debris from being received in the ball joint. Water leakage around the elastomeric ball joint seal and into the ball joints can cause corrosion of the ball and ball housing. Typically, a ball joint is packed with grease that is injected into the ball joint housing through a nipple, or pre-packed in no-service assemblies. The grease can serve to lubricate the ball shaft within the ball housing. A typical ball joint seal design has been utilized to trap the grease within the ball joint and prevent ingestion of external contaminants.

The design of the present disclosure provides a ball joint seal, including an annular seal body including a first axial end and second axial end. The first axial end includes at least one axially extending seal lip and at least one radially inwardly extending seal lip. At least one of the axially extending seal lips and at least one radially inwardly extending seal lip having a channel or flute extending therethrough to allow grease to migrate from the ball joint to the axial sealing surfaces of the seal through the radial seal beads and/or through the axial seal beads.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a ball joint dust seal according to the principles of the present disclosure;

FIG. 2 is a top plan view of the ball joint dust seal according to the principles of the present disclosure;

FIG. 3 is a cross-sectional view taken along line 3-3 of FIG. 2.

### DETAILED DESCRIPTION

The following description is merely exemplary in nature and is not intended to limit the present disclosure, application, or uses.

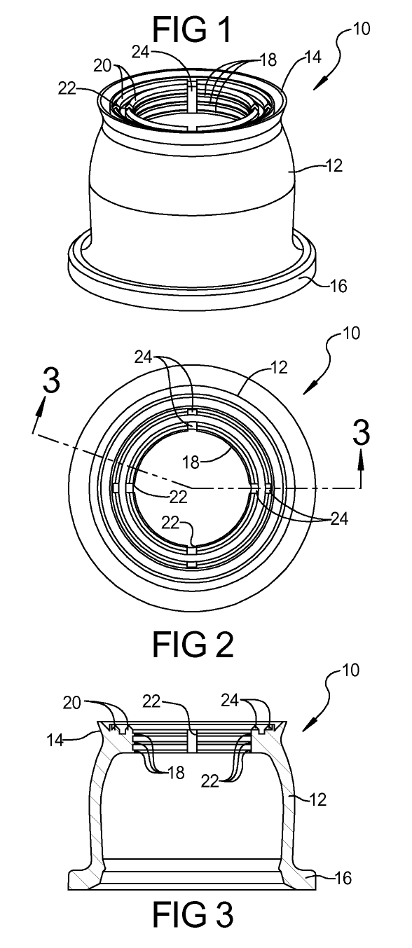

With reference to FIGS. 1-3, the ball joint dust seal 10, according to the principles of the present disclosure, will now be described. The ball joint dust seal 10 includes an annular elastomeric body 12 having a first, dynamic seal end 14 and a second, static seal end 16.

The first dynamic seal end 14 can include one or more radially inwardly extending seal beads or lips 18 and one or more axially extending seal beads or lips 20. The radially inwardly extending beads 18 can each include one or more channels or flutes 22 extending axially therethrough and the axially extending lips 20 can include one or more channels or flutes 24 extending radially therethrough. The channels 22, 24 allow grease or other lubricants internal to the seal 10 to migrate from the ball joint to the axially sealing surfaces 20 of the dynamic seal portion 14.

It should be understood that the number of channels 22, 24 can be modified as well as the shape of the channels to provide for desired grease migration. The concept can be applied to both purgible dust boots (for joints requiring service) and non-purgible dust boots (for lube-for-life applications).

The concept may be applicable to dust seals that require a clip at the static and/or dynamic seals. The ability to allow grease or other lubricant to migrate to the axially extending sealing surfaces 20 of the dynamic seal portion 14 extends the service life of the ball joint dust seal 10, thus extending the service life of the ball joint assembly. It should be further noted that the concept could further be applicable to other dynamic seals with multiple contact surfaces other than ball joint seals.

The second end portion 16 of the seal 10 is designed to be a static seal which is adapted to be mounted to the ball joint housing and generally, is not intended to be movable relative to the ball joint housing in its assembled condition.

What is claimed is:

1. A ball joint seal, comprising:
an annular seal body including a first axial end and a second axial end, said first axial end including at least one axially extending seal lip and at least one radially inwardly extending seal lip, at least one of said at least one axially extending seal lip and said at least one radially inwardly extending seal lip having a channel extending therethrough.

2. The ball joint seal according to claim 1, wherein said at least one axially extending seal lip has a radially extending channel extending therethrough and said at least one radially inwardly extending seal lip has an axially extending channel extending therethrough.

3. The ball joint seal according to claim 1, wherein said at least one axially extending seal lip has a plurality of radially extending channels extending therethrough and said at least one radially inwardly extending seal lip has a plurality of axially extending channels extending therethrough.

4. The ball joint seal according to claim 1, wherein said at least one of said at least one axially extending seal lip and said at least one radially inwardly extending seal lip has a plurality of channels extending therethrough.

5. The ball joint seal according to claim 2, wherein said at least one axially extending seal lip includes a plurality of axially extending seal lips having a radially extending channel extending therethrough.

6. The ball joint seal according to claim 5, wherein said plurality of axially extending seal lips each has a plurality of radially extending channels extending therethrough.

7. The ball joint seal according to claim 3, wherein said at least one radially extending seal lip includes a plurality of radially extending seal lips having an axially extending channel extending therethrough.

8. The ball joint seal according to claim 7, wherein said plurality of radially extending seal lips each has a plurality of axially extending channels extending therethrough.

9. A ball joint seal, comprising:
an annular seal body including a first axial end and a second axial end, said first axial end including at least one axially extending seal lip having a radially extending channel extending therethrough.

10. The ball joint seal according to claim 9, wherein said at least one axially extending seal lip has a plurality of radially extending channels extending therethrough.

11. The ball joint seal according to claim 9, wherein said at least one axially extending seal lip includes a plurality of axially extending seal lips having a radially extending channel extending therethrough.

12. The ball joint seal according to claim 11, wherein said plurality of axially extending seal lips each has a plurality of radially extending channels extending therethrough.

13. A ball joint seal, comprising:
an annular seal body including a first axial end and a second axial end, said first axial end including at least one radially inwardly extending seal lip having a channel extending therethrough.

14. The ball joint seal according to claim 13, wherein said at least one radially extending seal lip has a plurality of axially extending channels extending therethrough.

15. The ball joint seal according to claim 13, wherein said at least one radially extending seal lip includes a plurality of radially extending seal lips having an axially extending channel extending therethrough.

16. The ball joint seal according to claim 15, wherein said plurality of radially extending seal lips each has a plurality of axially extending channels extending therethrough.
